(19) United States
(12) Patent Application Publication
(10) Pub. No.: US 2014/0293204 A1
(43) Pub. Date: Oct. 2, 2014

(54) LIQUID CRYSTAL COMPOSITION AND LIQUID CRYSTAL DISPLAY PANEL THEREOF

(71) Applicant: Shenzhen China Star Optoelectronics Technology Co. Ltd., Shenzhen (CN)

(72) Inventors: Hong-Ji Huang, Shenzhen (CN); Xinhui Zhong, Shenzhen (CN)

(73) Assignee: Shenzhen China Star Optoelectronics Technology Co., Ltd., Shenzhen (CN)

(21) Appl. No.: 13/991,425

(22) PCT Filed: Apr. 9, 2013
(86) PCT No.: PCT/CN2013/073955

§ 371 Date: Jun. 4, 2013

(30) Foreign Application Priority Data
Mar. 28, 2013 (CN) 201310105882.3

(51) Int. Cl. C09K 19/56; G02F 1/1337

(52) U.S. Cl. CPC C09K 19/56; G02F 1/1337
USPC 349/130; 252/299.01

(57) ABSTRACT

The present invention discloses a liquid crystal composition for a polymer stabilized vertical alignment liquid crystal display (PS-VA LCD) and a liquid crystal display panel thereof; the liquid crystal composition comprises at least one type of negative liquid crystal material, a type of stabilizer and one or more type of reactive monomers; the structural formula of the reactive monomer consists of one benzene ring, two benzene rings or one naphthalene ring, the structure of two benzene rings is formed by connecting the two benzene rings directly or indirectly with a group, at least one polymerizable group is connected directly to the benzene ring and naphthalene ring, and at least one of polymerizable groups is an acrylate group. Reaction rate of the reactive monomer and uniformity of polymer bumps are improved by selecting polymerizable groups of the reactive monomer and controlling the content thereof to effectively solve quality issues of panels.

### FIELD OF THE INVENTION

The present invention relates to a liquid crystal composition, especially relates to a liquid crystal composition for a polymer stabilized vertical alignment liquid crystal display and a liquid crystal display panel thereof, wherein the liquid crystal composition comprise at least one type of negative liquid crystal material, a type of stabilizer and one or more type of reactive monomers.

### BACKGROUND OF THE INVENTION

In recent years, with the rapid development of information technology, mobile phone, computer and even common household appliances are being developed to be intelligent, convenient and portable, therefore efficiency of information exchange between human and computer become more critical. High efficiency, high-quality, high-capacity, portable, low-cost and low-energy monitor plays an important role in transmitting information processed by machine to human efficiently and clearly, so that traditional CRT monitors have been replaced by thin liquid crystal displays over the past few years.

Early liquid crystal displays were mostly twisted nematic (TN) mode or super twisted nematic (STN) mode, of which liquid crystal materials were positive nematic liquid crystals added a certain amount of chiral reagents. When the liquid crystal panel is powered off, long axis of a liquid crystal molecule is parallel to a surface of a substrate; the orientation of a liquid crystal molecule on a surface of a substrate is depended on frictional direction of an alignment layer which usually uses polyimide as materials; and, the alignment orientation of upper and lower substrates create a certain angle which is usually 90 degree. Therefore, molecules in the liquid crystal layer are in a continuous torsional state, and a liquid crystal display is TN mode when the twist angle is 90 degree or a liquid crystal display is STN mode when the twist angle is 270 degree. A liquid crystal display also has orthogonal polaroids attached on outside surface of the substrates along absorption axis and a backlight, besides the upper and lower substrates and liquid crystal layer. Lights from the backlight become linearly polarized lights after pass through the polaroid, then pass through the torsionally aligned liquid crystal layer that changing the polarization direction thereof to make it easy to pass through another polaroid, and then the display is in light-transmitting state at the moment. After applying voltage on the liquid crystal layer, the long axis of the liquid crystal molecule tends to align along electric field direction to reduce or eliminate the ability of the liquid crystal layer to change the polarization state of polarized light, and then the display is in opaque or poor light-transmitting state at the moment. Therefore, visibility of the liquid crystal display can be controlled by changing the applied voltage.

TN/STN liquid crystal display is one of the earlier commercialized displays and its application is greatly restricted due to its small angle of visibility, luminance difference and serious color shift issues in large visual angle mode. Then, although the visual angle and color shift issue of TN/STN liquid crystal display are improved at some degree by compensation films, manufacturing costs are increased and the result still cannot fully meet the people's needs of high-quality display.

Multi-domain vertical alignment liquid crystal displays, which use negative liquid crystal and vertical alignment film materials, give a good solution to visual angle restriction issues existing in the TN/STN liquid crystal displays. When no voltage is applied, long axis of a liquid crystal molecule is perpendicular to a surface of a substrate, and after applying voltage, the long axis of the liquid crystal molecule tends to align along electric field direction because applying voltage can tilt the negative liquid crystal molecules. For solving the viewing angle issue, a sub-pixel is divided into multiple regions to tilt liquid crystal molecule in different regions toward different direction, so that visual effects seen from different angle are coincident. There are several ways to tilt liquid crystal molecule in different regions of one sub-pixel towards different direction. The first method is to form full indium tin oxide electrodes (full ITO electrodes) on the upper and lower substrates by exposure and development and make bumps in dislocation mode on each full ITO electrode of the upper and lower substrates to create a certain pretilt angle of the liquid crystal molecules on or nearby the bumps, so that other liquid crystal molecules are guided to tilt towards a pre-set fixed direction. The second method, called patterned vertical alignment (PVA) technology, is to form patterned indium tin oxide electrodes (ITO electrodes) in dislocation on the upper and lower substrates for creating an electric field direction having a certain pretilt angle to control guidance of liquid crystal molecule in different regions. The third method, called polymer stabilized vertical alignment (PSVA) technology, is to form an ITO electrode having a certain pattern (usually fishbone-shaped) on thin-film transistor side of one LCD substrate and a full ITO electrode (full ITO) on the other substrate while polymerizable reactive monomers (RM) are added into the liquid crystal material, so that liquid crystal molecules in different regions are tilted towards a pre-set direction under the electric field, and an ultra violet polymerization reaction of reactive monomers in the liquid crystal materials is generated under UV-irradiation to form prominence of polymer that can tilt the liquid crystal molecule, which deposit on the surface of substrates for alignment. Compared with other MVA technologies, the PSVA technology has advantages of high penetration rate, high contrast and fast response and becomes one of the mainstream technologies for large size LCD panels.

The forming process of bumps in PSVA technology is a process of polymer inducing phase separation, wherein the reactive monomers are micromolecules having a better compatibility with liquid crystal molecules before polymerization and form macromolecules separated from the liquid crystal molecules to form polymer particles insoluble in liquid crystal molecules during the polymerization reaction under UV-irradiation, and the polymer particles are polymer bumps for alignment. Key step of the PSVA is to control the reaction of reactive monomers, such as reaction rate, uniformity of reaction and residual quantity after the reaction, to form right size and equally distributed bumps for good optical performance such as high contrast and fast response.

However, only one type of reactive monomer is usually adopted in the present PSVA technology, which may easily cause adverse reaction of the reactive monomer, for example, change of irradiation conditions may easily cause bigger bumps, so that the panels produced by the PSVA technology may have lightspots visible in the darkness and a decreased contrast. In addition, it's hard to control polymerization rate by adopting liquid crystal materials having only one type of reactive monomer. Therefore, there are still many aspects needs to be improved in the PSVA technology.

As a result, it is necessary to provide a backlight module to solve the problems existing in the conventional technologies.

### SUMMARY OF THE INVENTION

The present invention provides a backlight module to solve the problems of reliability of tube assembling existing in the conventional technologies.

The present invention provides a liquid crystal composition to solve the problems of reaction uniformity of reactive monomers existing in the conventional technologies.

The object of the present invention is to disclose a liquid crystal composition for PSVA technology, of which the size and uniformity of the bumps formed in polymerization reaction and the rate of polymerization reaction are controlled by adding one or more different reactive monomers, to help panels gain a perfect optical performance, an increased response speed and contrast and a shortened processing time.

Another object of the present invention is to provide a liquid crystal composition for PSVA liquid crystal displays. The species of reactive monomers and polymerizable groups are selected and matched, so that bumps with smaller size, better uniformity and higher density can be formed in polymerization reaction to increase response speed and contrast.

To achieve the above object of the present invention, one embodiment of the present invention provides a liquid crystal composition for polymer stabilized vertical alignment liquid crystal displays comprising: a type of negative liquid crystal material, a type of stabilizer and one or more type of reactive monomers; the reactive monomer accounts for 0.1% to 1% of the total amount of the liquid crystal composition by weight, and has at least one of the following structural formula:

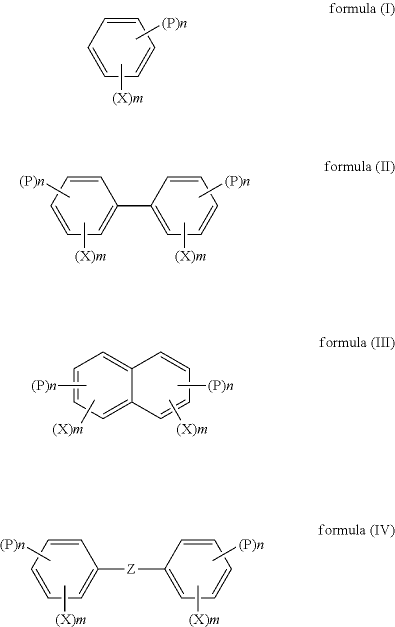

wherein, in the formula (I) to (IV), P represents a polymerizable group, n is the number of the polymerizable groups P connected to an identical aromatic ring which is an integer from 1 to 3, X represents a substituent group, m is the number of the substituent groups X connected to an identical aromatic ring which is an integer from 1 to 3; n plus m (nm) is less than the maximum number of the groups connectable to an identical aromatic ring, Z in the formula (IV) is —O—, —COO—, —OCO—, —CH₂O—, —OCH₂O—, —O(CH₂)₂O—, —COCH₂—, methylene group, —C≡C—,

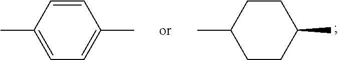

and wherein at least one of the polymerizable groups P in the formula (I) to (IV) is an acrylate group.

In one embodiment of the present invention, the polymerizable group is at least one selected from the group consisting of methacrylate group, acrylate group, vinyl group, ethyleneoxy group and epoxy group.

In one embodiment of the present invention, the polymerizable groups are identical or different groups when n is greater than 1.

In one embodiment of the present invention, the substituent group X is at least one selected from the group consisting of —F, —Cl, —Br, methyl group, —CN and a straight-chain or a branched alkyl group comprising 2 to 8 carbon atoms in which one or more non-adjacent methyl groups are replaced by oxygen or sulfur atoms.

In one embodiment of the present invention, the substituent groups X are identical or different groups when m is greater than 1.

In one embodiment of the present invention, n plus m is less than the maximum number of the groups connectable to an identical aromatic ring.

In one embodiment of the present invention, at least one of the n and m representing the number of group P and X is different while one or more type of the reactive monomers has the same structural formula.

In one embodiment of the present invention, one or more hydrogen atoms of any aromatic ring in the structural formula of the reactive monomer are replaced by the following groups: —Cl, —Br, methyl group or —CN.

In one embodiment of the present invention, one or more hydrogen atoms of any non aromatic ring in the structural formula of the reactive monomer are replaced by the following groups: —F, —Cl, —Br or methyl group.

In one embodiment of the present invention, the negative liquid crystal material contains at least one type of negative liquid crystal molecule having the following structural formula:

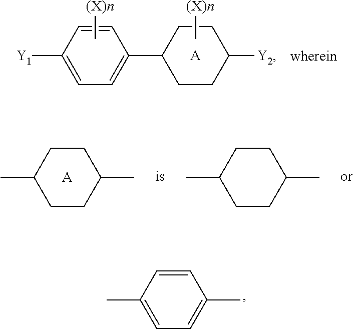

X represents a substituent group connected to the ring which is at least one selected from the group consisting of —H, —F, —Cl, —Br, —I, —CN and —NO₂; n is an integer from 1 to 4, n of different rings are equal or unequal, and the substituent groups X are identical or different groups when n is larger than 1; Y₁ and Y₂ are —R, —O—R, —CO—R, —OCO—R, —COO—R or —(OCH₂CH₂)CH₃ independently, wherein R represents a straight-chain or a branched alkyl group comprising 1 to 12 carbon atoms, n1 is an integer from 1 to 5, and Y₁ and Y₂ are identical or different.

In one embodiment of the present invention, the stabilizer comprises at least one stabilizer molecule represented by the following formula:

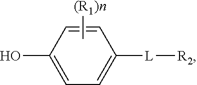

wherein R₁ is at least one of straight-chain or branched alkyl groups comprising 1 to 9 carbon atoms, n is an integer from 1 to 4, substituent groups R₁ are identical or different groups when n is larger than 1, R₂ represents a straight-chain or a branched alkyl group comprising 1 to 36 carbon atoms, and L is carbon-carbon single bond, —O—, —COO—, —OCO—, —CH₂O—, —OCH₂O—, —O(CH₂)₂O—, —COCH₂— or methylene group.

In one embodiment of the present invention, the type of reactive monomer is more than one, and the molar ratio of any one type of the reactive monomer in the total reactive monomer is less than 98%.

In one embodiment of the present invention, the content of the stabilizer accounts for 0.001% to 1% of the liquid crystal composition.

Another embodiment of the present invention provides a liquid crystal panel comprising a first substrate provided with a first alignment film, a second substrate provided with a second alignment film, and the liquid crystal composition for a polymer stabilized vertical alignment liquid crystal display, as mentioned above, filled between the first and second substrates.

### DESCRIPTION OF THE INVENTION

Preferred embodiments are set forth in order to make the purpose, characteristic and advantage of the present invention more comprehensible. Moreover, the direction words mentioned in the present invention, such as up, down, front, back, left, right, inside, outside and side are set forth in order to illustrate, not to limit, the present invention.

In a first embodiment of the present invention, a liquid crystal composition for polymer stabilized vertical alignment (PSVA) liquid crystal displays is provided, which comprises a liquid crystal material, a stabilizer and one or more type of reactive monomers (RM) that can generate polymerization reaction under irradiation of ultraviolet. The liquid crystal material contains at least one negative liquid crystal molecule having the following structural formula:

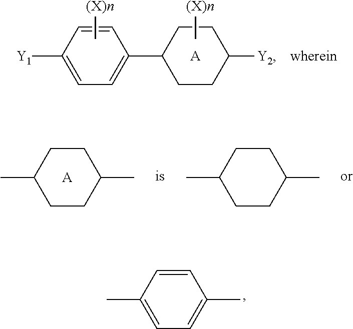

X represents a substituent group connected to the ring, such as —H, —F, —Cl, —Br, —I, —CN and —NO₂; n is an integer from 1 to 4, n of different rings are equal or unequal, and the substituent groups X are identical or different groups when n is larger than 1; Y₁ and Y₂ are identical or different substituent groups. For example, the liquid crystal material is a negative liquid crystal molecule and has the following structural formula:

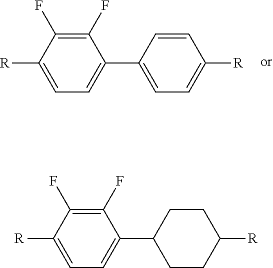

Wherein R represents a straight-chain or a branched alkyl group comprising 1 to 9 carbon atoms and one or more non-adjacent methyl groups or methyl groups in the alkyl group are replaced by oxygen or sulfur atoms. The liquid crystal material may also be a liquid crystal molecule which is not substituted by double bond, that is, the liquid crystal material is a liquid crystal molecule only substituted by alkyl groups such as a conventional vertical alignment liquid crystal molecule (VA-LC).

Furthermore, the stabilizer comprises at least one type of stabilizer molecule represented by the following formula:

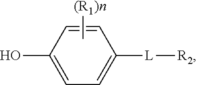

wherein R₁ is at least one of straight-chain or branched alkyl groups comprising 1 to 9 carbon atoms, n is an integer from 1 to 4, substituent groups R₁ are identical or different groups when n is larger than 1, R₂ represents a straight-chain or a branched alkyl group comprising 1 to 36 carbon atoms, and L is carbon-carbon single bond, —O—, —COO—, —OCO—, —CH₂O—, —OCH₂O—, —O(CH₂)₂O—, —COCH₂— or methylene group. For example, the stabilizer comprises at least one stabilizer represented by the following formula:

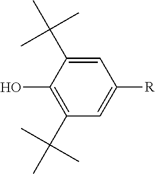

wherein R is a straight-chain or branched alkyl groups comprising 1 to 30 carbon atoms and one or more non-adjacent methyl groups or methylene groups in the alkyl group are replaced by oxygen or sulfur atoms. The liquid crystal composition remains stable during storage, transport, etc. by adding the stabilizer to prevent from an advanced polymerization reaction of the reactive monomer.

Furthermore, the reactive monomer has at least one of the following structural formula:

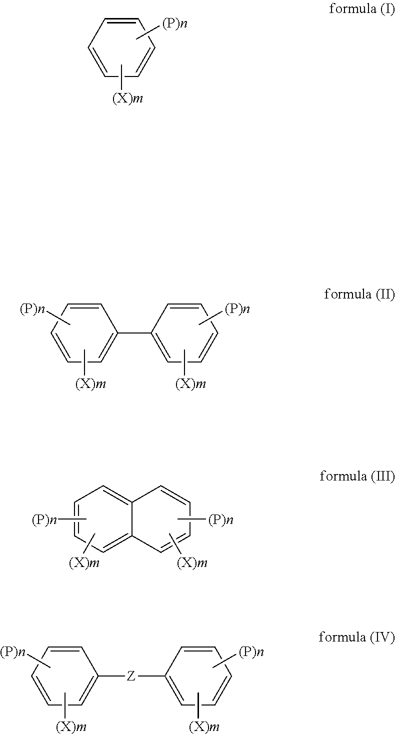

wherein, in the formula (I) to (IV), P represents a polymerizable group and is at least one selected from the group consisting of methacrylate group, acrylate group, vinyl group, ethyleneoxy group and epoxy group; n is the number of the polymerizable groups P connected to an identical aromatic ring which is an integer from 1 to 3, polymerizable groups P are identical or different groups when n is larger than 1; X represents a substituent group and is at least one selected from the group consisting of —F, —Cl, —Br, methyl group, —CN and a straight-chain or a branched alkyl group comprising 2 to 8 carbon atoms in which one or more non-adjacent methyl groups are replaced by oxygen or sulfur atoms; m is the number of the substituent groups X connected to an identical aromatic ring which is an integer from 1 to 3; n plus m is less than the maximum number of the groups connectable to an identical aromatic ring; and Z in the formula (IV) is —O—, —COO—, —OCO—, —CH₂O—, —OCH₂O—, —O(CH₂)₂O—, —COCH₂—, methylene group, —C≡C—

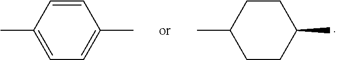

In a preferred embodiment of the present invention, at least one of the polymerizable groups P in the formula (I) to (IV) is an acrylate group. At least one of the n or m representing the number of group P or X is different while one or more reactive monomers have the same structural formula. In addition, in the structural formula (I) to (IV) of the reactive monomer, one or more hydrogen atoms are replaced by —F, —Cl, —Br, methyl group or —CN; one or more hydrogen atoms of any non aromatic ring in the structural formula of the reactive monomer are replaced by —F, —Cl, —Br or methyl group.

In a preferred embodiment of the present invention, the type of reactive monomer is more than one, and the molar ratio of any one type of the reactive monomer in the total reactive monomer is less than 98%, for example, when there are two types of reactive monomer, the molar ratio of one is 52 to 90% and another one is 10 to 48%.

In a preferred embodiment of the present invention, the content of the liquid crystal material accounts for 20% to 90%, such as 25%, 35%, 50%, 80%, etc., of the liquid crystal composition by weight. The content of the stabilizer accounts for 0.001% to 1%, such as 0.001%, 0.005%, 0.03%, 0.2%, 0.5% or 0.85%, of the liquid crystal composition by weight. The content of the reactive monomer accounts for 0.1% to 1%, such as 0.15%, 0.25%, 0.3%, 0.5%, 0.75%, etc., of the liquid crystal composition by weight.

In a second embodiment of the present invention, a liquid crystal panel is provided, which comprises: a first substrate provided with a first alignment film, a second substrate provided with a second alignment film, and the liquid crystal composition filled between the first and second substrates. The liquid crystal composition is diffused on surfaces of the first and second substrate. The first substrate is a color filter substrate and the second substrate is a thin film transistor array substrate. The first and second alignment films are both vertical alignment-alignment films.

According to the liquid crystal composition of the present invention, the reactive monomer reacts with the alignment film containing polyimide to form alignment polymer for guidance of liquid crystal molecules of the liquid crystal materials, and with control of the content of the reactive monomer and selection of the substituent groups of the reactive monomer, the polymerization reaction rate of the reactive monomer under ultraviolet irradiation is increased and size of guiding bumps formed is smaller which resulted in a better uniformity, so that quality of liquid crystal panels is improved, formation of highlight is reduced and contrast as well as response speed is promoted.

The present invention has been described with relative embodiments which are examples of the present invention only. It should be noted that the embodiments disclosed are not the limit of the scope of the present invention. Conversely, modifications to the scope and the spirit of the claims, as well as the equal of the claims, are within the scope of the present invention.

What is claimed is:

1. A liquid crystal composition for a polymer stabilized vertical alignment liquid crystal display, comprising: a type of negative liquid crystal material, a type of stabilizer and one or more type of reactive monomers; the reactive monomer accounts for 0.1% to 1% of the total amount of the liquid crystal composition by weight, and has at least one of the following structural formula: 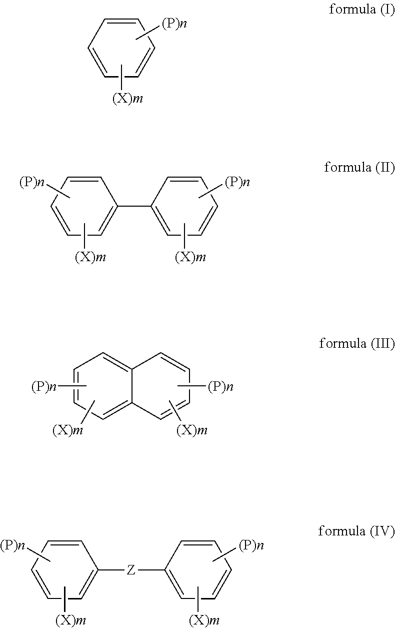
wherein, in the formula (I) to (IV), P represents a polymerizable group, n is the number of the polymerizable groups P connected to an identical aromatic ring which is an integer from 1 to 3, X represents a substituent group, m is the number of the substituent groups X connected to an identical aromatic ring which is an integer from 1 to 3, n plus m is less than the maximum number of the groups connectable to an identical aromatic ring, and Z in the formula (IV) is —O—, —COO—, —OCO—, —CH₂O—, —OCH₂O—, —O(CH₂)₂O—, —COCH₂—, methylene group, —C≡C—, 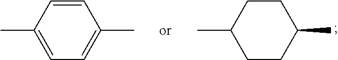
and
wherein at least one of the polymerizable groups P in the formula (I) to (IV) is an acrylate group;
wherein the type of the reactive monomer is more than one, and the molar ratio of any one type of the reactive monomer in the total reactive monomer is less than 98%; and
the content of the stabilizer accounts for 0.001% to 1% of the liquid crystal composition.

2. A liquid crystal composition for a polymer stabilized vertical alignment liquid crystal display, comprising: a type of negative liquid crystal material, a type of stabilizer and one or more type of reactive monomers; the reactive monomer accounts for 0.1% to 1% of the total amount of the liquid crystal composition by weight, and has at least one of the following structural formula: 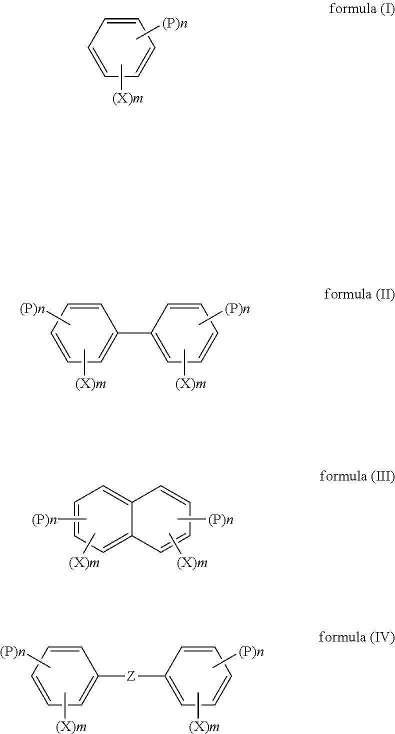
wherein, in the formula (I) to (IV), P represents a polymerizable group, n is the number of the polymerizable groups P connected to an identical aromatic ring which is an integer from 1 to 3, X represents a substituent group, m is the number of the substituent groups X connected to an identical aromatic ring which is an integer from 1 to 3, n plus m is less than the maximum number of the groups connectable to an identical aromatic ring, and Z in the formula (IV) is —O—, —COO—, —OCO—, —CH₂O—, —OCH₂O—, —O(CH₂)₂O—, —COCH₂—, methylene group, —C≡C—, 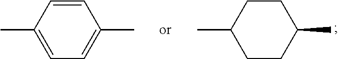
and
wherein at least one of the polymerizable groups P in the formula (I) to (IV) is an acrylate group.

3. The liquid crystal composition for the polymer stabilized vertical alignment liquid crystal display according to claim 2, wherein the polymerizable groups P is at least one selected from the group consisting of methacrylate group, acrylate group, vinyl group, ethyleneoxy group and epoxy group.

4. The liquid crystal composition for the polymer stabilized vertical alignment liquid crystal display according to claim 2, wherein the polymerizable groups P are identical or different groups.

5. The liquid crystal composition for the polymer stabilized vertical alignment liquid crystal display according to claim 2, wherein the substituent groups X are identical or different groups when m is greater than 1.

6. The liquid crystal composition for the polymer stabilized vertical alignment liquid crystal display according to claim 2, wherein n plus m is less than the maximum number of the groups connectable to an identical aromatic ring.

7. The liquid crystal composition for the polymer stabilized vertical alignment liquid crystal display according to claim 2, wherein at least one of the n and m representing the number of group P and X is different while one or more type of the reactive monomers has the same structural formula.

8. The liquid crystal composition for the polymer stabilized vertical alignment liquid crystal display according to claim 2, wherein the substituent group X is at least one selected from the group consisting of —F, —Cl, —Br, methyl group, —CN and a straight-chain or a branched alkyl group comprising 2 to 8 carbon atoms in which one or more non-adjacent methyl groups are replaced by oxygen or sulfur atoms.

9. The liquid crystal composition for the polymer stabilized vertical alignment liquid crystal display according to claim 2, wherein one or more hydrogen atoms of any aromatic ring in the structural formula of the reactive monomer are replaced by the following group: —F, —Cl, —Br, methyl group or —CN.

10. The liquid crystal composition for the polymer stabilized vertical alignment liquid crystal display according to claim 2, wherein one or more hydrogen atoms of any non aromatic ring in the structural formula of the reactive monomer are replaced by the following group: —F, —Cl, —Br or methyl group.

11. The liquid crystal composition for the polymer stabilized vertical alignment liquid crystal display according to claim 2, wherein the negative liquid crystal material contains at least one type of negative liquid crystal molecule having the following structural formula: 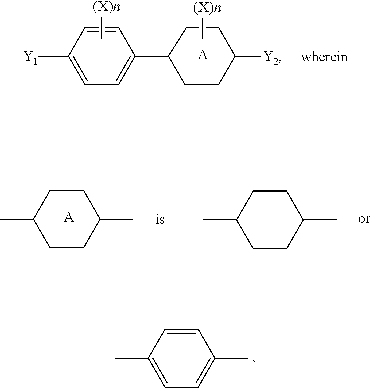
X represents a substituent group connected to the ring which is at least one selected from the group consisting of —H, —F, —Cl, —Br, —I, —CN and —NO₂; n is an integer from 1 to 4, n of different rings are equal or unequal, and the substituent groups X are identical or different groups when n is larger than 1; Y₁ and Y₂ are —R, —O—R, —CO—R, —OCO—R, —COO—R or —(OCH₂CH₂)ₙ₁CH₃ independently, wherein R represents a straight-chain or a branched alkyl group comprising 1 to 12 carbon atoms, n1 is an integer from 1 to 5, and Y₁ and Y₂ are identical or different.

12. The liquid crystal composition for the polymer stabilized vertical alignment liquid crystal display according to claim 2, wherein the stabilizer comprises at least one stabilizer molecule represented by the following formula: 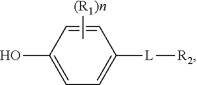
wherein R₁ is at least one of straight-chain or branched alkyl groups comprising 1 to 9 carbon atoms, n is an integer from 1 to 4, substituent groups R₁ are identical or different groups when n is larger than 1, R₂ represents a straight-chain or a branched alkyl group comprising 1 to 36 carbon atoms, and L is carbon-carbon single bond, —O—, —COO—, —OCO—, —CH₂O—, —OCH₂O—, —O(CH₂)₂O—, —COCH₂— or methylene group.

13. The liquid crystal composition for the polymer stabilized vertical alignment liquid crystal display according to claim 2, wherein the type of the reactive monomer is more than one, and the molar ratio of any one type of the reactive monomer in the total reactive monomer is less than 98%.

14. The liquid crystal composition for the polymer stabilized vertical alignment liquid crystal display according to claim 2, wherein the content of the stabilizer accounts for 0.001% to 1% of the liquid crystal composition.

15. A liquid crystal panel, comprising:
a first substrate provided with a first alignment film,
a second substrate provided with a second alignment film, and
a liquid crystal composition for a polymer stabilized vertical alignment liquid crystal display filled between the first and second substrates,
wherein the liquid crystal composition comprises: a type of negative liquid crystal material, a type of stabilizer and one or more type of reactive monomers; the reactive monomer accounts for 0.1% to 1% of the total amount of the liquid crystal composition by weight, and has at least one of the following structural formula: 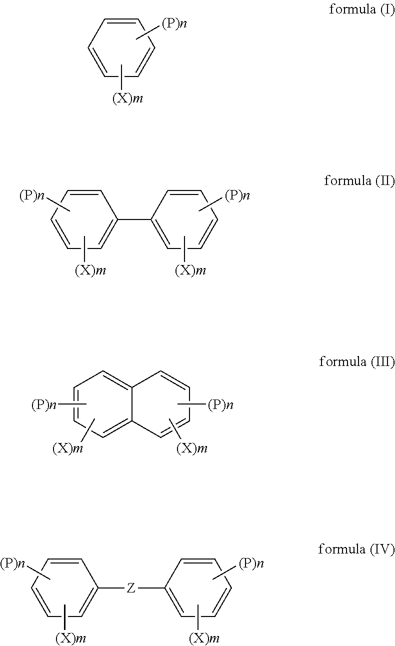
wherein, in the formula (I) to (IV), P represents a polymerizable group, n is the number of the polymerizable groups P connected to an identical aromatic ring which is an integer from 1 to 3, X represents a substituent group, m is the number of the substituent groups X connected to an identical aromatic ring which is an integer from 1 to 3, n plus m is less than the maximum number of the groups connectable to an identical aromatic ring, and Z in the formula (IV) is —O—, —COO—, —OCO—, —CH₂O—, —OCH₂O—, —O(CH₂)₂O—, —COCH₂—, methylene group, —C≡C—, 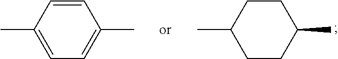
and
wherein at least one of the polymerizable groups P in the formula (I) to (IV) is an acrylate group.
